(19) United States
(12) Patent Application Publication
(10) Pub. No.: US 2011/0159339 A1
(43) Pub. Date: Jun. 30, 2011

(54) BATTERY WITH A HEAT CONDUCTING PLATE

(75) Inventors: Matthias Gregor, Stuttgart (DE); Rainer Kaufmann, Stuttgart (DE); Volker Keck, Stuttgart (DE); Arnold Lamm, Elchingen (DE); Jens Meintschel, Bernsdorf (DE); Dirk Schroeter, Winnenden (DE); Petra Schulz, Esslingen (DE); Wolfgang Warthmann, Weinstadt (DE)

(73) Assignee: Daimler AG, Stuttgart (DE)

(21) Appl. No.: 12/528,998

(22) PCT Filed: Feb. 26, 2008
(86) PCT No.: PCT/EP2008/001494

§ 371 Date: Mar. 17, 2011

(30) Foreign Application Priority Data
Feb. 27, 2007 (DE) 10 2007 010 739.2

(51) Int. Cl. H01M 10/50

(52) U.S. Cl. 429/120

(57) ABSTRACT

The invention relates to a battery with a heat conducting plate for controlling the temperature of the battery. The battery comprises a plurality of single cells connected in parallel and/or in series to each other, the cells being connected to the heat conducting plate in a heat conducting manner. In the heat conducting plate, a channel structure for a heat conducting medium is provided. In the region of the poles of the single cells, the heat conducting plate comprises bores through which the poles of the single cells extend.

The invention relates to a battery with a heat conducting plate for temperature control of the battery according to the preamble of claim 1, as for example known from the generic DE 197 24 020 A1 taken as a basis.

The previously known battery from DE 197 24 020 A1 taken as a basis has several single cells connected in parallel and/or in series, which are deposited on a heat conducting plate and are connected therewith in a heat conducting manner. An evaporator section of a heat pipe is arranged in the heat conducting plate. The heat pipe is conducted out of the heat conducting plate, especially out of the battery housing, whereby the condensation section of the heat pipe is outside the heat conducting plate. With this arrangement of the heat pipe, the heat conducting plate and thus the single cells can be temperature-controlled, especially cooled during operation. Especially with Li ion batteries, an overload and/or a high current withdrawal can lead to a strong pressure build-up of the single cells, which can finally lead to bursting of the cell housing of the respective single cell. So as to ensure a specified pressure reduction, it is sensible to arrange a single cell in the bottom of the housing, at which the single cell can burst in a specified manner. For improving this pressure reduction, it is further sensible to provide the heat conducting plate with continuous bores or recesses below the assembly place of the single cells—called bursting windows in the following in a simplified manner—. The diameter of the bursting windows is slightly smaller than the outer diameter of the cell housing. The bursting windows still lead to a reduction of the effective heat conducting cross section of the heat conducting plate, whereby their possible efficiency is reduced.

It is the object of the invention to develop a battery which can be realized as simple and as cost-effective as possible with an efficiency of the heat conduction as high as possible.

The object is solved with a battery with the characteristics of claim 1. This can now be arranged in the top region of the single cells by the formation of a heat conducting plate according to the invention. Although the heat conducting plate also has to be provided with bores here, but their surface is considerably smaller, so that the center surface-related effective heat conducting cross section is increased. By this, it is again possible with a constant entire heat conducting cross section to design the heat conducting plate thinner and thus lighter.

In further arrangements of the invention, an electrically insulating and preferably heat conducting layer is arranged within the battery housing in the gaps between the heat conducting plate on the one hand and the poles, the electrical cell connectors, the cell cover and the battery box cover, and in the spaces between the single cells, especially preferred a highly heat conducting casting mass and/or an electrically insulating and preferably heat conducting, especially preferred highly heat conducting foam, filled with an electrically insulating and preferably heat conducting, especially preferred highly heat conducting casting mass and/or an electrically insulating and preferably heat conducting, especially preferred highly heat conducting foam. These spaces within the battery housing are used more efficiently for the heat conduction by all these arrangements, wherein the stability of the entire battery housing is increased simultaneously.

Single cells according to the invention can especially be used for high performance batteries, especially for the at least partial drive of a motor vehicle for passenger transport.

Further sensible arrangements of the invention can be taken from the respective dependent claims. Furthermore, the invention is explained in more detail by means of the embodiments shown in the drawings. It shows thereby:

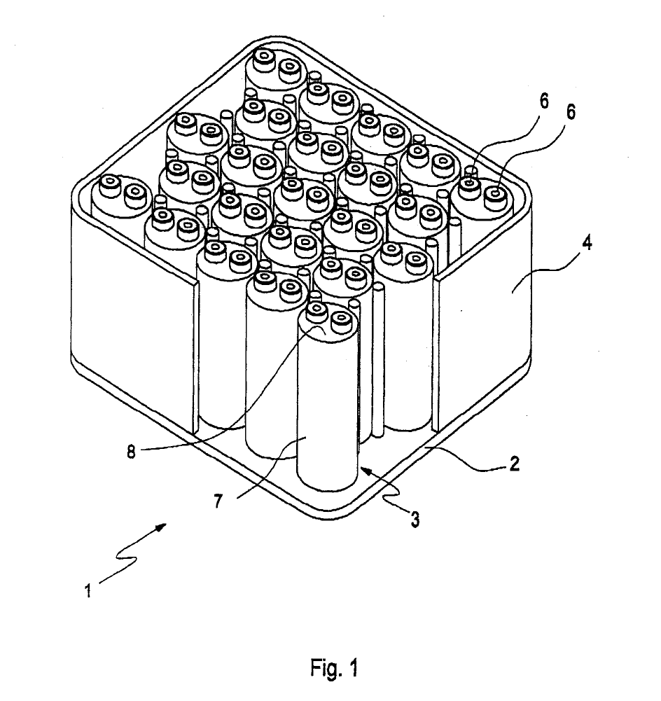

FIG. 1 a battery with a heat conducting plate arranged at the bottom,

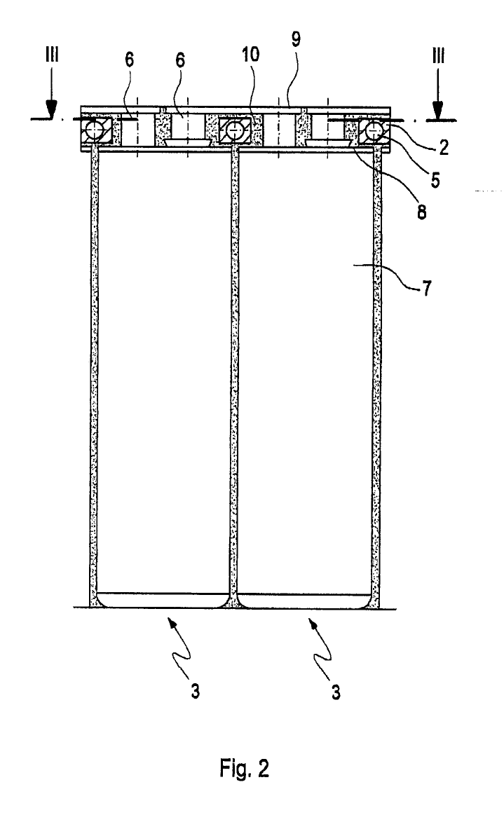

FIG. 2 a battery with a heat conducting plate arranged at the top in a longitudinal section in a side view,

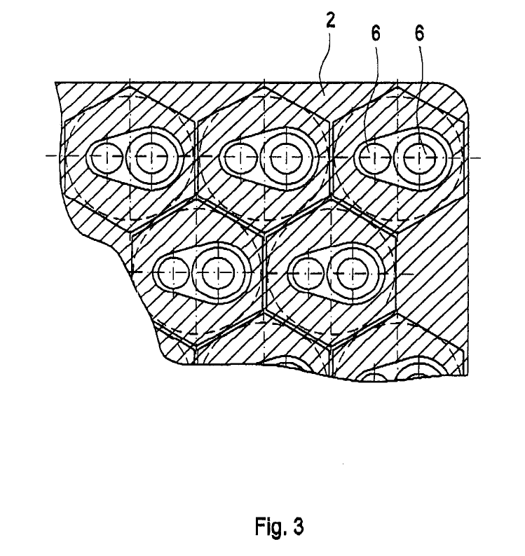

FIG. 3 a horizontal section below the electrical cell connectors along line III-III according to FIG. 2 in plan view.

In FIG. 1 is shown a usual battery 1 with a heat conducting plate 2 arranged at the bottom. The battery 1 has amongst others several single cells 3 connected electrically to one another. The single cells 3 preferably round in their cross section are arranged in an especially completely closed battery housing 4. Within the battery housing 4, the single cells 3 are deposited in a heat-conducting manner on the heat conducting plate 2 formed as a metal plate. Cooling channels 5 for conducting a heat conducting medium are arranged in the heat conducting plate 2. The arrangement of the single cells 3 on the heat conducting plate 2 takes place with its longitudinal axes parallel to one another.

When such a battery 1 is used, especially as a traction and traction aid battery of a motor vehicle, the cooling channels 5 can be connected in a sensible manner to an air conditioning unit (not shown) already present in the vehicle and be supplied by this at least partially on the heat side. This heat supply can be connected directly to the air conditioning unit for example via a common heat conducting medium, especially a fluid. It can also cooperate indirectly with the air conditioning unit, for example via a heat exchanger. In a preferred manner, the heat conducting medium can also be the air escaping from the air-conditioned interior of the vehicle and/or be supplied with this air.

In FIG. 2 is shown a longitudinal section of a battery 1 according to the invention in a side view. Contrary to the battery 1 according to FIG. 1 similar in construction to a large part, the heat conducting plate 2 is not arranged on both sides as known up to now, but rather on the top, and thus in the region of the poles 6 of the single cells 3. The cell housings 7 of the single cells 3 aligned parallel to their longitudinal extension have a distance to one another on their outer surface.

The heat conducting plate 2 preferably made of metal, which is provided for the temperature control of the battery 1, also has a channel structure for a heat conducting medium in its interior which can be flown through and operated from the outside. According to the invention, the heat conducting plate 2 is arranged between the cell housing covers 8 of the single cells 3 and the electrical cell connectors 9, which connect oppositely poled poles 6 of adjacent single cells 3.

Both poles 6 of a single cell 3 are conducted through a bore arranged in the heat conducting plate 2 and associated with these poles 6 to the opposite side of the heat conducting plate 2. The cell connectors 9 are arranged on this side. As the form and the clear measurements of a bore associated with the pole(s) is larger than the outer measurements of one or both poles 6 of a single cell 3, the poles 6 projecting through the bores have a distance from the walls of the bore everywhere (see FIG. 3). The poles 6 and the heat conducting plate 2 do not contact each other hereby in any case, whereby they are electrically insulated with regard to one another.

The heat conducting plate 2 also has an electrically insulating distance from the cell housing covers 8 and also from the cell connectors 9.

For improving the mutual electrical insulation, for increasing the stability of the entire battery housing 4, and for improving the entire heat conductivity, an electrically insulating and preferably heat conducting, especially preferred highly heat conducting casting mass and/or an electrically insulating and preferably heat conducting, especially preferred highly heat conducting foam is arranged in the gaps between the heat conducting plates 2 and the poles 6 on the one hand, and the electrical cell connectors 9 and the cell housing covers 8, and also the battery box cover, which preferably fills these gaps completely. The free spaces between the walls of adjacent cell housings, and also the free spaces between the walls of the cell housings and the wall of the battery box 4 are also filled in the same manner in an advantageous manner.

As casting mass 14, electrically insulating but heat conducting materials as preferably polyurethane foams, epoxy resins and/or silicones have proved themselves. The respective free spaces are cast as depleted from bubbles as possible and especially preferred free from bubbles. In an advantageous manner, the materials for the casting mass can be further improved with regard to their heat conduction by adding heat conducting particles, which are arranged distributed in the type of a well mixed mixture in the material.

1-9. (canceled)

10. A battery with a heat conducting plate for controlling the temperature of the battery, comprising:
several single cells mutually connected in parallel, in series, or both in parallel and in series and connected in a heat conducting fashion with the heat conducting plate,
a channel structure arranged in the heat conducting plate, through which channel structure a heat conducting medium can flow, and
connection cross-sections for the channel structure that lead out of the heat conducting plate,
wherein the heat conducting plate has bores in a region of poles of the single cells, and the poles of the single cells project through the bores, and
wherein at least one of an electrically insulating and preferably heat conducting casting mass, particularly preferably a highly heat conducting casting mass, and an electrically insulating and preferably heat conducting foam, particularly preferably a highly heat conducting foam, is arranged within the battery housing in a gap between the heat conducting plate and the poles.

11. The battery according to claim 10, wherein at least one of an electrically insulating and preferably heat conducting casting mass, particularly preferably a highly heat conducting casting mass, and an electrically insulating and preferably heat conducting foam, particularly preferably a highly heat conducting foam, is arranged within the battery housing in the gap between the heat conducting plate and the electric cell connectors.

12. The battery according to claim 10, wherein at least one of an electrically insulating and preferably heat conducting casting mass, particularly preferably a highly heat conducting casting mass, and an electrically insulating and preferably heat conducting foam, particularly preferably a highly heat conducting foam, is arranged within the battery housing in the gap between the heat conducting plate and the cell cover,

13. The battery according to claim 10, wherein at least one of an electrically insulating and preferably heat conducting casting mass, particularly preferably a highly heat conducting casting mass, and an electrically insulating and preferably heat conducting foam, particularly preferably a highly heat conducting foam, is arranged within the battery housing in the gap between the heat conducting plate and the battery box cover.

14. The battery according to claim 10, wherein the gap is filled completely by at least one of the casting mass and the foam.

15. The battery according to claim 10, wherein the heat conducting plate is made of metal, and the heat conducting plate is electrically insulated with respect to the single cells of the battery.

16. The battery according to claim 10, wherein inside diameters of the bores are larger than outside diameters of respective poles.

17. The battery according to claim 10, wherein the form and measurements of a bore are larger than outer dimensions of both poles of an individual cell.
